(19) United States
(12) Patent Application Publication
(10) Pub. No.: US 2019/0156785 A1
(43) Pub. Date: May 23, 2019

(54) METHOD AND APPARATUS FOR REFRESH RATE REGIONS ON VIDEO-MODE DISPLAY PANELS

(71) Applicant: QUALCOMM Incorporated, San Diego, CA (US)

(72) Inventors: Dileep MARCHYA, Hyderabad (IN); Balamukund SRIPADA, Hyderabad (IN); Srinivas PULLAKAVI, Kakinada (IN)

(21) Appl. No.: 15/818,650

(22) Filed: Nov. 20, 2017

(51) Int. Cl. G09G 5/10

(52) U.S. Cl. CPC G09G 5/10; G09G 2330/021; G09G 2310/061; G09G 2310/08

(57) ABSTRACT

A method and system for displaying image data on a video-mode display panel is provided. Instead of continuously refreshing the entire display panel, the display panel may be divided into a first frame region and a second frame region. Each frame region may be associated with its own refresh rate. A higher refresh rate can be provided to content such as video playback and scrolling where a higher refresh rate is required for improved user experience and reduce visual artifacts. A lower refresh rate can be provided to other content, thus saving power where higher refresh rate is not required.

### BACKGROUND

### Field

The technology of the disclosure relates generally to video-mode display panels on computing devices.

### Background

Computing devices have become common in almost every facet of everyday activity. Commonly, computing devices have some form of user interface. Many such user interfaces include some way a user can provide input to the computing device as well as a display through which the user can view output from the computing device. A relatively recent trend is the incorporation of a touch screen display panels that allows the input and the output functions to be combined in a single device.

Various specifications define and control how data is sent from a control system (sometimes referred to as a host or host processor) to a display device such as a display panel. The MIPI® Alliance has provided the Display Serial Interface (DSI) specification as one specification for data transfer between host processors and display panel. DSI-compatible display panels can be generally classified in two categories:

A. Command-mode display panels, where the display panel is self-refreshed from internal panel RAM. The DSI host processor transfers updated portion of the frame buffer at the rate of content refresh rate to the panel.

B. Video-mode display panels, where the display panel is refreshed by the DSI host processor. The host processor transfers an entire framebuffer at a constant refresh rate. The refresh rate may range from, for example, 30-60 Hz depending on the display panel's capacitor discharge rate. The display panel is refreshed at one of the refresh rates in this range based on various runtime parameters. Video-mode panels are widely used in the communication devices due to lower price in comparison to command mode panels.

### SUMMARY

In one embodiment, a system for displaying image data is discussed. The system may include a host processor configured to provide a frame of image data to a bus, the frame including a first frame region and a second frame region, wherein the first frame region is provided at a first refresh rate and the second frame region is provided at a second refresh rate, wherein the first refresh rate is faster than the second refresh rate. The system may include a video-mode display panel. The video-mode display panel may include a bus interface coupled to the bus and configured to receive the frame. The video-mode display panel may include a display screen including a plurality of pixel elements for displaying the frame, wherein the first frame region is displayed at the first refresh rate and the second frame region is displayed at the second refresh rate. The first refresh rate may be an integer multiple of the second refresh rate. The second refresh rate may exceed a display screen minimum refresh rate. The second refresh rate may exceed a content refresh rate associated with the second frame region. The first frame region may include faster-changing image data displayed at the first refresh rate and the second frame region may include slower-changing image data displayed at the second refresh rate. The system may include a timing controller, the timing controller configured to provide a first clock signal driving the first refresh rate and a second clock signal driving the second refresh rate, wherein the first refresh rate is independent of the second refresh rate. The host processor may be further configured to communicate a first offset associated with the first frame region and a second offset associated with the second frame region to the video-mode display panel before providing the stored frame to the bus. The first offset and the second offset may be communicated via a DSI protocol extension command. The video-mode display panel may receive the frame, the first offset, and the second offset via the bus, wherein the bus may be a DSI bus.

In another embodiment, a method for displaying image data is discussed. The method may include providing, by a host processor, a frame of image data to a bus, the frame including a first frame region and a second frame region, wherein the first frame region is provided at a first refresh rate and the second frame region is provided at a second refresh rate, wherein the first refresh rate is faster than the second refresh rate. The method may include receiving, by a bus interface coupled to the bus, the frame. The method may include displaying the frame, at a display screen including a plurality of pixel elements, wherein the first frame region is displayed at the first refresh rate and the second frame region is displayed at the second refresh rate, wherein the bus interface and the display screen are components in a video-mode display panel. The first refresh rate may be an integer multiple of the second refresh rate. The second refresh rate may exceed a display screen minimum refresh rate. The second refresh rate may exceed a content refresh rate associated with the second frame region. The first frame region may include faster-changing image data displayed at the first refresh rate and the second frame region may include slower-changing image data displayed at the second refresh rate. The method may include providing a first clock signal driving the first refresh rate and a second clock signal driving the second refresh rate by a timing controller, wherein the first refresh rate is independent of the second refresh rate. The host processor may be further configured to communicate a first offset associated with the first frame region and a second offset associated with the second frame region to the video-mode display panel before providing the stored frame to the bus. The first offset and the second offset may be communicated via a DSI protocol extension command. The video-mode display panel may receive the frame, the first offset, and the second offset via the bus, wherein the bus may be a DSI bus.

In another embodiment, a system for displaying image data is discussed. The system may include a host processor means configured to provide a frame of image data to a bus, the frame including a first frame region and a second frame region, wherein the first frame region is provided at a first refresh rate and the second frame region is provided at a second refresh rate, wherein the first refresh rate is faster than the second refresh rate. The system may include a video-mode display panel means. The video-mode display panel means may include a bus interface means coupled to the bus and configured to receive the frame. The video-mode display panel means may include a display screen means including a plurality of pixel elements for displaying the frame, wherein the first frame region is displayed at the first refresh rate and the second frame region is displayed at the second refresh rate. The first refresh rate may be an integer multiple of the second refresh rate. The second refresh rate may exceed a display screen minimum refresh rate. The second refresh rate may exceed a content refresh rate associated with the second frame region. The first frame region may include faster-changing image data displayed at the first refresh rate and the second frame region may include slower-changing image data displayed at the second refresh rate. The system may include a timing controller means, the timing controller means configured to provide a first clock signal driving the first refresh rate and a second clock signal driving the second refresh rate, wherein the first refresh rate is independent of the second refresh rate. The host processor means may be further configured to communicate a first offset associated with the first frame region and a second offset associated with the second frame region to the video-mode display panel before providing the stored frame to the bus. The first offset and the second offset may be communicated via a DSI protocol extension command The video-mode display panel means may receive the frame, the first offset, and the second offset via the bus, wherein the bus may be a DSI bus.

In another embodiment, a non-transient computer-readable storage medium containing program instructions for causing a computer to perform a method is discussed. The method may include providing, by a host processor, a frame of image data to a bus, the frame including a first frame region and a second frame region, wherein the first frame region is provided at a first refresh rate and the second frame region is provided at a second refresh rate, wherein the first refresh rate is faster than the second refresh rate. The method may include receiving, by a bus interface coupled to the bus, the frame. The method may include displaying the frame, at a display screen including a plurality of pixel elements, wherein the first frame region is displayed at the first refresh rate and the second frame region is displayed at the second refresh rate, wherein the bus interface and the display screen are components in a video-mode display panel. The first refresh rate may be an integer multiple of the second refresh rate. The second refresh rate may exceed a display screen minimum refresh rate. The second refresh rate may exceed a content refresh rate associated with the second frame region. The first frame region may include faster-changing image data displayed at the first refresh rate and the second frame region may include slower-changing image data displayed at the second refresh rate. The method may include providing a first clock signal driving the first refresh rate and a second clock signal driving the second refresh rate by a timing controller, wherein the first refresh rate is independent of the second refresh rate. The host processor may be further configured to communicate a first offset associated with the first frame region and a second offset associated with the second frame region to the video-mode display panel before providing the stored frame to the bus. The first offset and the second offset may be communicated via a DSI protocol extension command. The video-mode display panel may receive the frame, the first offset, and the second offset via the bus, wherein the bus may be a DSI bus.

### BRIEF DESCRIPTION OF THE DRAWINGS

FIG. 1 illustrates exemplary high refresh rate regions of various smartphone applications.

FIG. 2 illustrates a block diagram of an exemplary computing system with a host and a client coupled by a display serial interface (DSI) bus.

FIG. 3 illustrates a block diagram of an exemplary processor-based system that can include the computing system of FIG. 2.

FIG. 4 illustrates a block diagram of an exemplary video-mode display panel system.

FIGS. 5A and 5B illustrates screenshots of exemplary solutions.

FIGS. 6A and 6B illustrates exemplary processes for supporting multiple refresh rate regions on a video-mode display panel.

FIG. 7 illustrates an exemplary timing diagram enabling data transfer over two virtual channels at different refresh rates for different regions.

### DETAILED DESCRIPTION

With reference now to the drawing, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

In video-mode display panels, the DSI specification expects data transfer of an entire frame buffer for every refresh. Thus, the entire display is refreshed continuously even if only a small region is refreshing at a relatively high frame rate. This leads to higher power consumption. To reduce power consumption, the display panel may be divided into a first frame region and a second frame region, where each frame region is associated with its own refresh rate. A higher refresh rate can be provided to content such as video playback and scrolling where a higher refresh rate is required for improved user experience and reduce visual artifacts. A lower refresh rate can be provided to other content, thus saving power where higher refresh rate is not required.

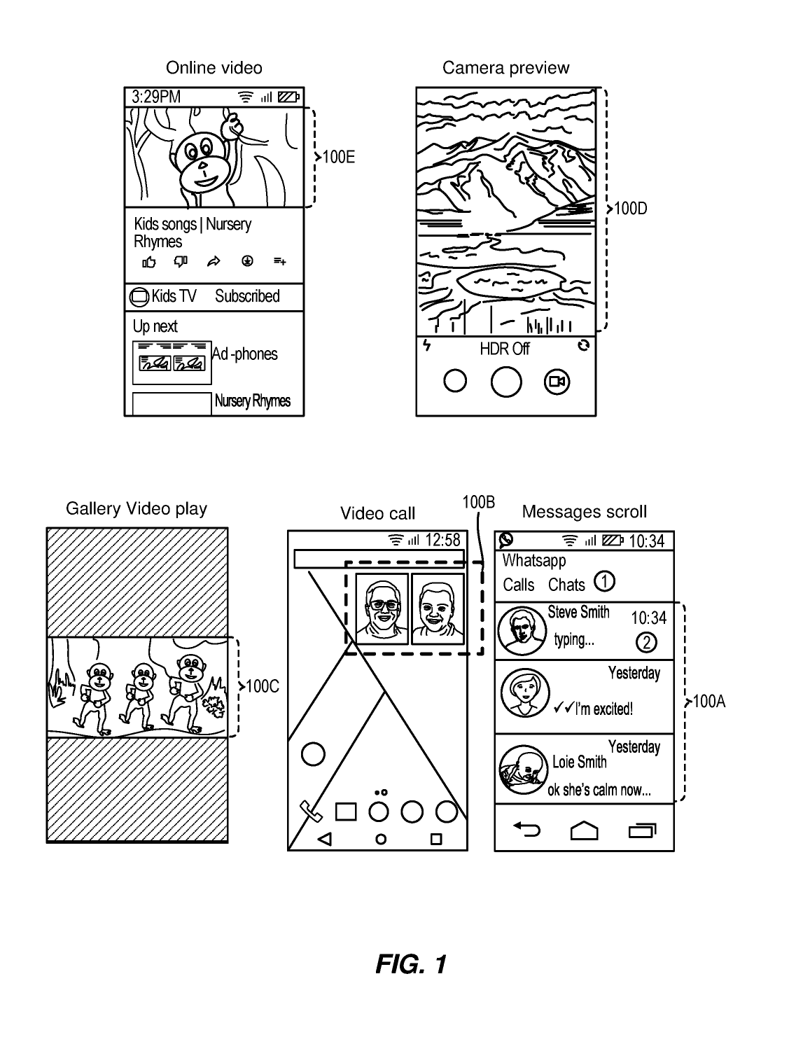

FIG. 1 illustrates exemplary high refresh rate regions of various smartphone applications. Many smartphone applications only require some portion of the screen refreshed at high frame rates. This includes widely used applications like Whatsapp, Chrome, Camera, Text messaging, Video conferencing, Video playback etc. For example, FIG. 1 illustrates five example displays while executing smartphone applications. Screen regions 100A, 100B, 100C, 100D, and 100E may be areas requiring high refresh rates for improved user experience and reduced visual artifacts. In contrast, background, menus, black bars to ensure aspect ratio, user input widgets, etc. may be tolerant of lower refresh rates without impacting user experience or producing visual artifacts.

Video-mode display panels are frequently used in value tier segment smartphones. Power savings in this segment will enhance battery life and improve performance in this product segment. [to background]

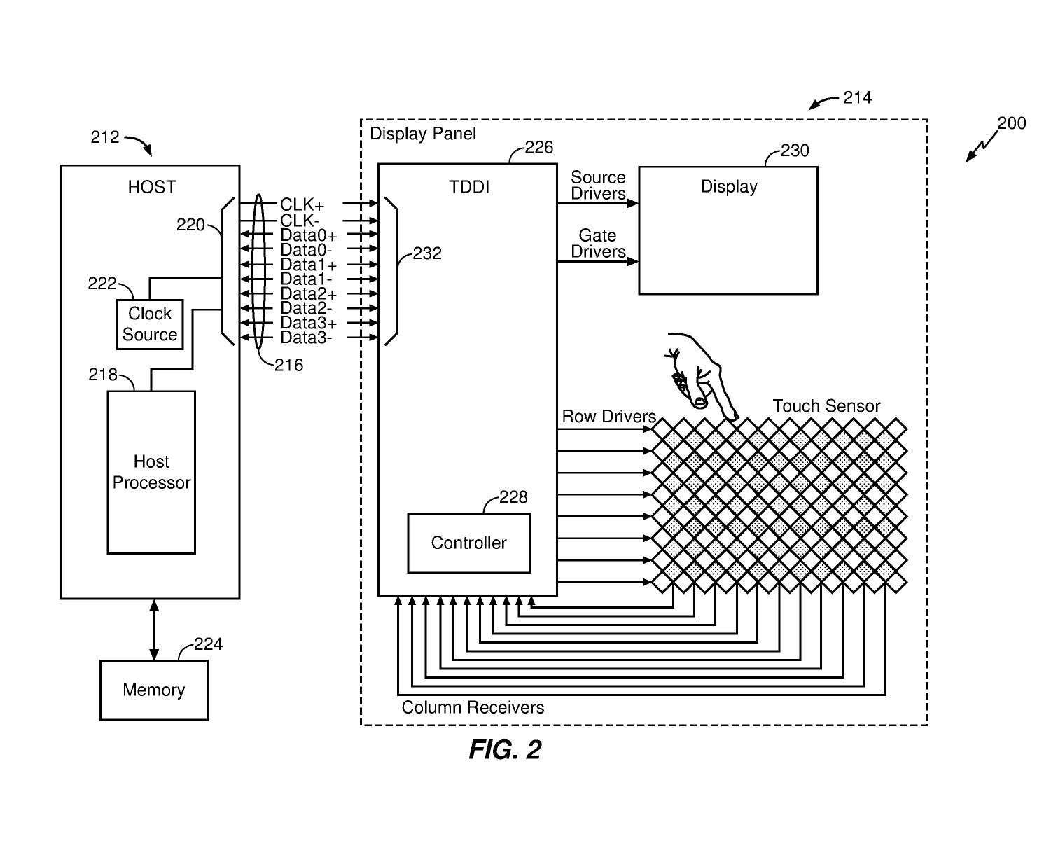

FIG. 2 illustrates a block diagram of an exemplary computing system with a host and a client coupled by a display serial interface (DSI) bus. For example, coupling can occur over mechanical connections such as wires or other conductive materials configured to carry signals. Alternatively, coupling can occur wirelessly between transmitter and receiver. An exemplary computing system 200 is formed from a host 212 and a client display panel 214 coupled by a bus 216. In an exemplary aspect, the host 212 is a first integrated circuit and includes a host processor 218 and an interface 220 that is configured to couple to the bus 216. Further, the host 212 may include a clock source 222. The interface 220 may include pins (not illustrated) configured to convey data onto conductive elements within the bus 216. The pins effectively form lanes through which signals may be passed to and from the client display panel 214. In an exemplary aspect, there are four data lanes (DATA0-DATA3) and a clock lane. The clock source 222 is used to provide a clock signal on the clock lane. In an exemplary aspect, the interface 220 generally complies with the DSI specification (i.e., the interface 220 may be a DSI bus interface) as modified by exemplary aspects of the present disclosure herein. While a modified DSI specification is particularly contemplated, other specifications may also benefit from the present disclosure. The host 212 may further be associated with a memory 224.

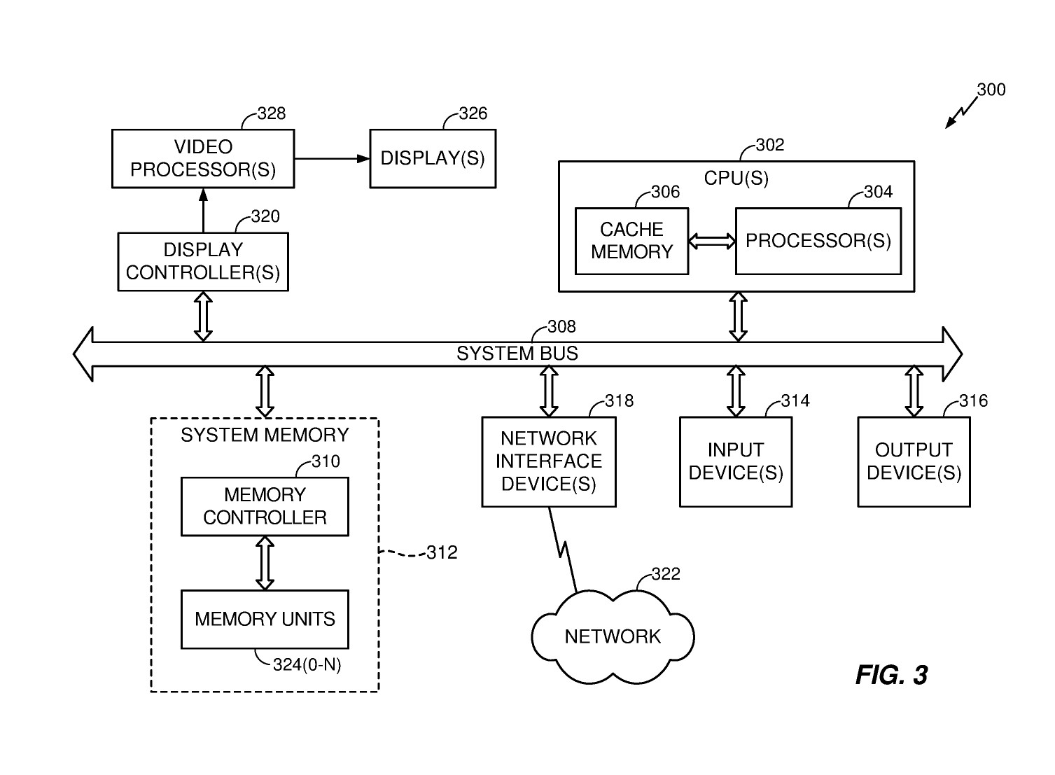

With continued reference to FIG. 2, the client display panel 214 may also be an integrated circuit and may include a Twisted-pair Distributed Data Interface (“TDDI”) 226 that includes a client microcontroller 228. Both the TDDI 226 and the client microcontroller 228 may be low-cost devices because DSI video-model display panels may not have robust processing requirements. The TDDI 226 includes necessary and sufficient drivers (e.g., source drivers and gate drivers) to operate a display 230, which may be a liquid crystal display (LCD) or the like, based on data provided over the four data lanes. The client display panel 214 further includes an interface 232 configured to couple to the bus 216 and as such may be a DSI bus interface. The interface 232 is described in greater detail below with reference to FIG. 3.

With continued reference to FIG. 2, the TDDI 226 receives data such as stylus input data, touch screen input data, gesture camera data, or the like. While there is an industry trend to integrate a signal processor into the TDDI 226, the present disclosure focuses on providing raw data or minimally processed data to the host 212 so that the more powerful host processor 218 may process the data. Such arrangement may reduce the cost of the integrated circuit for the client display panel 214 as well as reduce space and power consumption within the client display panel 214.

FIG. 3 illustrates a block diagram of an exemplary processor-based system that can include the computing system of FIG. 2. In this regard, FIG. 3 illustrates an example of a processor-based system 300 that can employ the computing system 200 illustrated in FIG. 2. In this example, the processor-based system 300 includes one or more central processing units (CPUs) 302, each including one or more processors 304. The CPU(s) 302 may be the host processor 218. The CPU(s) 302 may have cache memory 306 coupled to the processor(s) 304 for rapid access to temporarily stored data. The CPU(s) 302 is coupled to a system bus 308 and can intercouple master and slave devices included in the processor-based system 300. As is well known, the CPU(s) 302 communicates with these other devices by exchanging address, control, and data information over the system bus 308. For example, the CPU(s) 302 can communicate bus transaction requests to a memory controller 310 as an example of a slave device. Although not illustrated in FIG. 3, multiple system buses 308 could be provided, wherein each system bus 308 constitutes a different fabric.

Other master and slave devices can be connected to the system bus 308. As illustrated in FIG. 3, these devices can include a memory system 312, one or more input devices 314, one or more output devices 316, one or more network interface devices 318, and one or more display controllers 320, as examples. The input device(s) 314 can include any type of input device, including, but not limited to, input keys, switches, voice processors, touch, styli, etc. Note that while illustrated as being attached to the system bus 308 as separate elements, an integrated touch screen display panel 230 may be coupled to the CPU 302 through a DSI bus 216. The output device(s) 316 can include any type of output device, including, but not limited to, audio, video, other visual indicators, etc. The network interface device(s) 318 can be any devices configured to allow exchange of data to and from a network 322. The network 322 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 318 can be configured to support any type of communications specification desired. The memory system 312 can include one or more memory units 324(0-N).

The CPU(s) 302 may also be configured to access the display controller(s) 320 over the system bus 308 to control information sent to one or more displays 326. The display controller(s) 320 sends information to the display(s) 326 to be displayed via one or more video processors 328, which process the information to be displayed into a format suitable for the display(s) 326. The display(s) 326 can include any type of display, including, but not limited to, a cathode ray tube (CRT), an LCD, a plasma display, a light emitting diode (LED) display, etc.

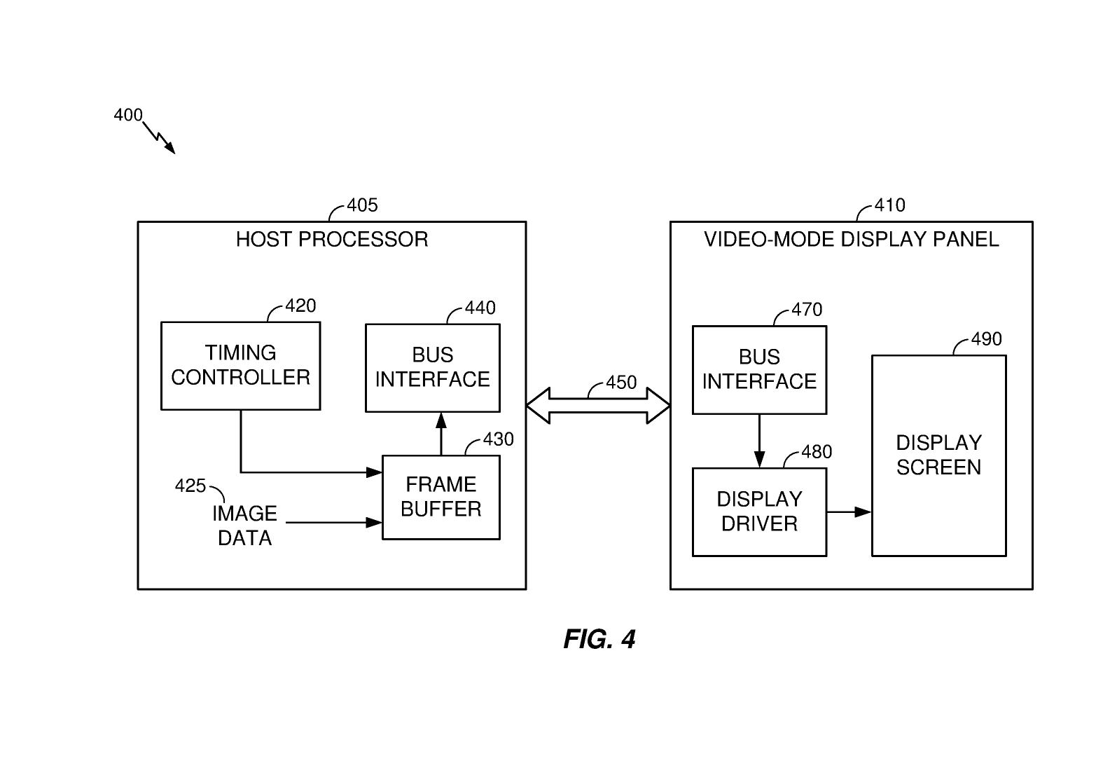

FIG. 4 illustrates a block diagram of an exemplary video-mode display panel system 400. The video-mode system 400 includes a host (or application) processor 405 and a video-mode display panel 410, which communicate via communication bus (“bus”) 450. The host processor 405 is configured to send image data to the video-mode display panel 410 via the bus 450, and the host processor 405 and the video-mode display panel 410 may send control information via the bus 450. The host processor 405 includes a timing controller 420 in communication with a frame buffer 430. The timing controller 420 uses synchronization signals to control the transfer of data from the frame buffer 430 to the bus interface 440 (see for example, vsync signals 310, 360 and 410 in FIGS. 3A, 3B, and 4, respectively). The host processor 405 also includes a frame buffer 430 that is in communication with a bus interface 440. The frame buffer 430 receives image data 425 and temporarily stores it, and provides the image data to the bus interface 440. The image data 425 includes pixel information of a series of frames to be transferred to the video-mode display panel 410. The bus interface 440 is coupled to the bus 450, which in turn is coupled to a bus interface 470 of the video-mode display panel. The host processor 405 may be implemented as one or more electronic hardware processors, in various implementations.

The video-mode display panel 410 includes the bus interface 470 which is coupled to the bus 450 and configured to receive image data from the host processor 405. The video-mode display panel 410 also includes a display panel 490 comprising a plurality of pixel elements for displaying the image data. The video-mode display panel 410 also includes a display driver 480 that is coupled to the bus interface 470 and the display panel 490. The host processor 405 transfers image data that includes a series of frames of pixel information (such as “video data”) from the frame buffer 430 over bus interface 440 and bus 450 at a video rate, such as sixty (60) frames per second. The display driver 480 reads the series of frames of image data from the bus interface 470 and writes the frames to the display screen 490.

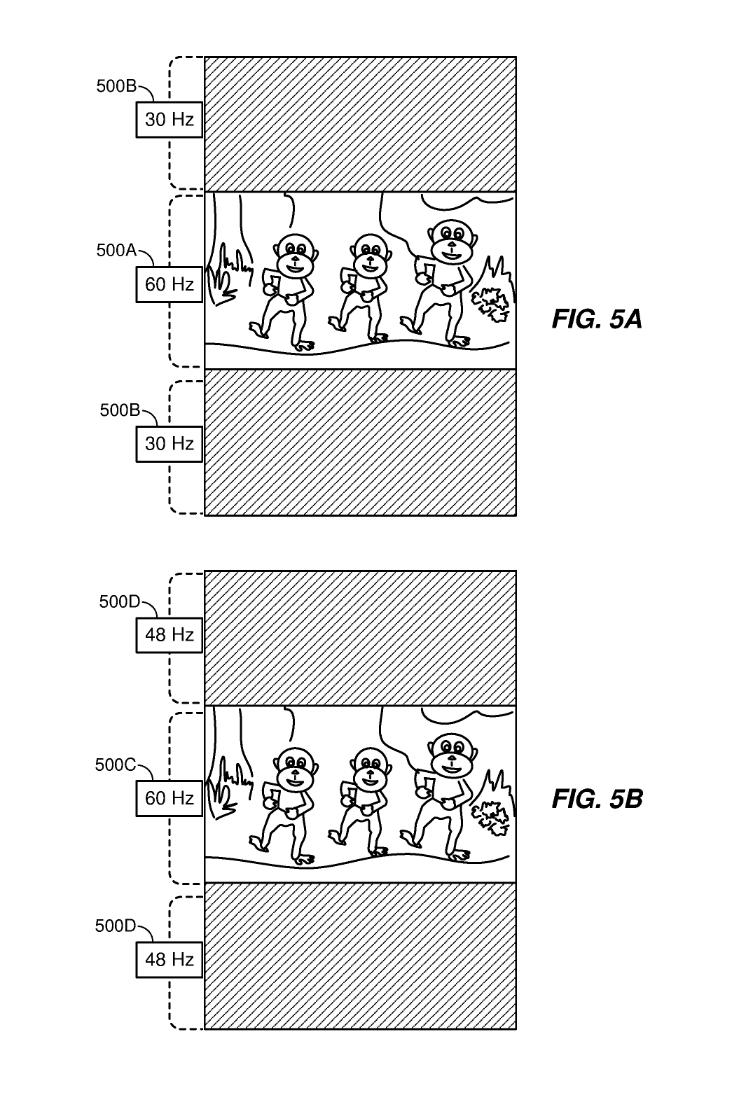

FIGS. 5A and 5B illustrates screenshots of exemplary solutions. FIG. 5A illustrates a first exemplary solution that does not require additional hardware enhancements. A host processor (as illustrated above) may provide a video for display and playback on a video-mode display panel. The video may be a series of frames of image data, each frame including pixel information. As illustrated in FIG. 5A, the frame may include a first frame region 500A and a second frame region 500B. The first frame region 500A may include a video for playback at a higher first frame rate, for example, 60 Hz or 60 frames-per-second (fps). The second frame region 500B may include static background, for example, static areas at the top and bottom of the display panel to ensure proper aspect ratio of the video. As such, the second frame region 500B can be refreshed at a lower second frame rate, for example, 30 Hz.

In this exemplary solution, the first frame rate can be a multiple of the second frame rate. This allows the solution to be implemented in the computing systems illustrated above driven by a single timing engine.

In the example screenshot of FIG. 5A, a host processor includes a timing controller driving the display panel refresh at 60 Hz or 60 fps. First region 500A is displaying a video playback and can be refreshed by the host processor to a bus at the full 60 Hz. Second region 500B may only display black regions or user interface controls, and can therefore be refreshed at a lower rate without impacting user experience. In this example, the second region 500B can be refreshed every other clock cycle, or 30 Hz. This reduces power consumption associated with refreshing the second region 500B every single clock cycle. It will be appreciated that the second region 500B can alternatively be refreshed every third, forth, or any integer multiple clock cycle, limited by the performance of the display panel such as a minimum panel refresh rate.

FIG. 5B illustrates a second exemplary solution. A host processor (as illustrated above) may provide a video for display and playback on a video-mode display panel. The video may be a series of frames of image data, each frame including pixel information. As illustrated in FIG. 5B, the frame may include a first frame region 500C and a second frame region 500D. The first frame region 500C may include a video for playback at a higher first frame rate, for example, 60 Hz. The second frame region 500D may include static background, for example, static areas at the top and bottom of the display panel to ensure proper aspect ratio of the video. As such, the second frame region 500D can be refreshed at a lower second frame rate, for example, 48 Hz.

In some situations, it may be difficult to set the first frame rate as a multiple of the second frame rate. For example, the desired multiple may exceed a maximum frame rate for the display panel. A minimum frame rate associated with the video for display, the video-mode display panel, and other factors can be determined as discussed below. In such situations, better performance may be obtained by setting the second frame rate approximately equal to the minimum frame rate. This may require additional host processor enhancements such as additional timing controllers to allow independent refresh rates between the different frame regions.

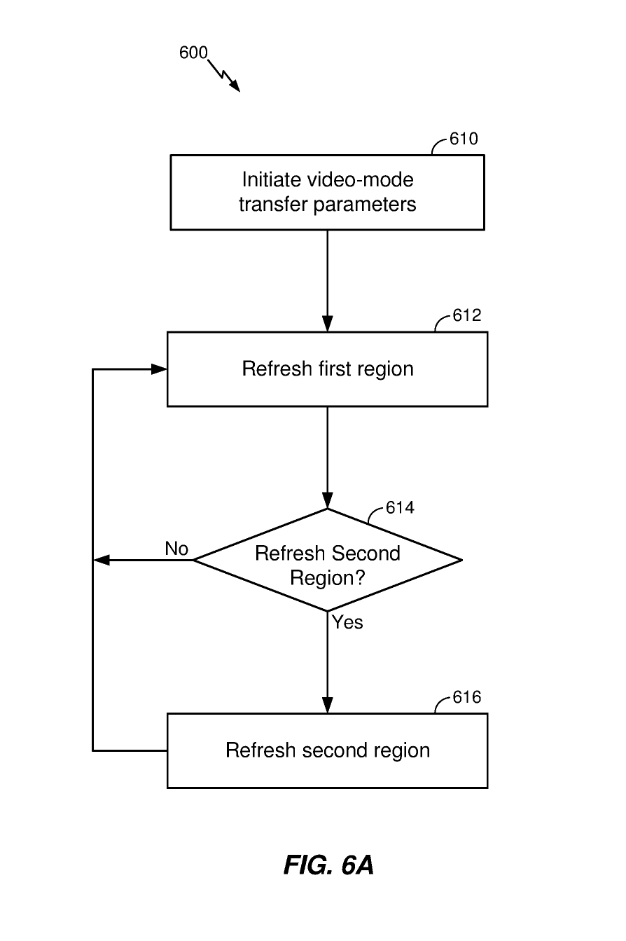

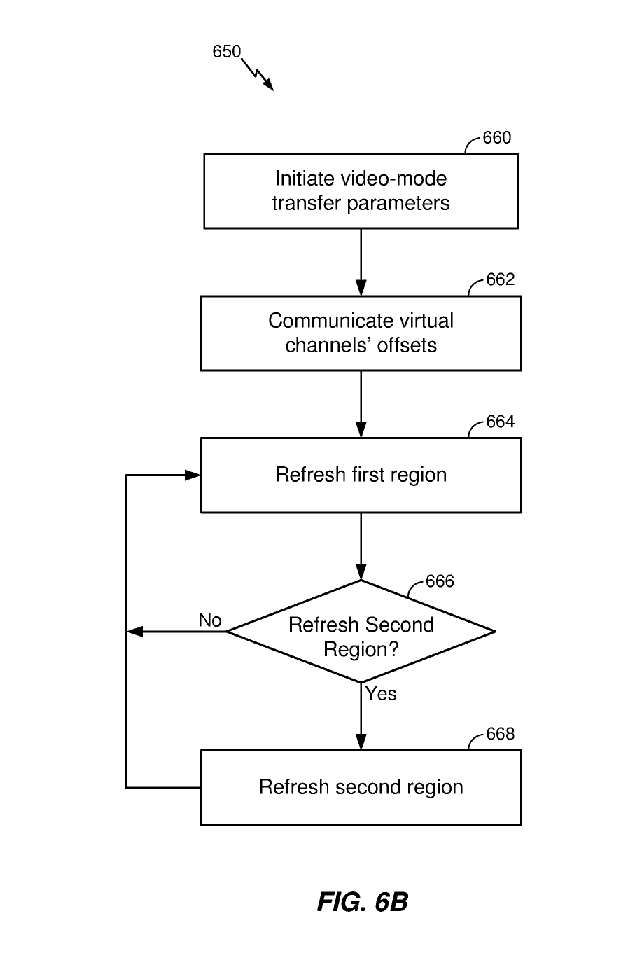

FIGS. 6A and 6B illustrates exemplary processes for supporting multiple refresh rate regions on a video-mode display panel. FIG. 6A illustrates an example process 600 for supporting multiple refresh rate regions on a video-mode display panel without an additional timing controller driving a second refresh rate.

In 610, the process may initiate video-mode transfer parameters associated with multiple refresh rate regions. For example, the host processor may determine a panel operating frequency range, including a minimum refresh rate and a maximum refresh rate. This can be based on the hardware specification of the display panel. For example, the minimum refresh rate can based on how long display panel capacitors can retain a charge between refreshing without producing visual artifacts or blank spaces. The minimum refresh rate can be set to exceed this period to ensure the display panel is refreshed before the charge dissipates. The maximum refresh rate can be determined by how fast pixel elements of the display panel can change in response to refreshing.

The host processor can analyze a video including a series of frames to be displayed at the display panel. The video can be divided into a first region and a second region. The first region and the second region may include different content for display at different refresh rates. For example, the first region can include faster-changing content and the second region can include slower-changing content, as discussed above. In this example, the second region does not need to be refreshed by the host processor as often as the first region.

In one example, the first region and the second region can each be mapped to a different application layer by the host processor. To initiate the transfer, the host processor can transfer a first frame of the video to be displayed.

In 612, the host processor can receive a subsequent frame to be displayed. In one example, this can be a stored frame to be displayed. The subsequent frame can be divided into first region and second region as discussed. The host processor refreshes first region.

In 614, the host processor checks whether the second region needs to be refreshed. The second region, including slower-changing video content, can be refreshed at a lesser rate than the first region. For example, the second region may be refreshed every second, third, or other integer multiple cycle. The host processor can access or update a counter to determine how many first region refreshes have occurred. If no refresh of the second region is required, the process returns to 612 where the first region is refreshed with a subsequent frame. If a refresh is required, the process continues to 616. It will be appreciated that the process can be extended to any number of regions, each region associated with its own refresh rate.

In 616, host processor refreshes the second region of the subsequent frame. The process returns to 612 and continues until refreshing is no longer required, for example, when the video content has completed playback.

FIG. 6B illustrates an example process 650 for supporting multiple refresh rate regions on a video-mode display panel with an additional timing controller driving a second refresh rate. In 660, the process may initiate video-mode transfer parameters associated with multiple refresh rate regions similar to the above process. For example, the host processor may determine a panel operating frequency range, including a minimum refresh rate and a maximum refresh rate. The host processor may analyze a video include a series of frames to be displayed at the display panel and divide the video into a first region and a second region. It will be appreciated that any number of regions may be supported.

In 662, the host processor may transmit a MIPI DSI protocol extension command, initiating a state to communicate a horizontal offset, for example, a first offset, and a vertical offset, for example, a second offset, for each virtual channels to be used. For example, each region of the video can be associated with a virtual channel and defined by the associated offsets. In one example, up to four virtual channels can be supported by the MIPI DSI protocol.

In this example, the host processor may support independent timing engines for each channel For example, this may be implemented with timing controllers capable of driving different refresh rates for each region. In this example, the controllers may provide a first clock signal and a second clock signal. Thus, the refresh rates of the regions do not depend on each other, unlike the process illustrated in FIG. 6A.

In one example, the host processor may identify and cluster frame buffer regions with similar refresh rate requirements. Furthermore, the host processor may limit the number of unique refresh regions to a maximum number of virtual channels, as defined in the MIPI DSI protocol. In a further example, each region may be associated with a region of interest, as defined in the MIPI DSI protocol.

For example, a porch may be a non-active region of a virtual channel, or anything outside a region of interest. In one example, the host processor may compute a horizontal porch and a vertical porch of each virtual channel for every refresh rate to ensure that there is no overlap and timing collision with data transfers of other regions. The host processor may further transmit the porches along with the horizontal and vertical panel offsets at beginning of data transfer to the display panel.

The host process may then transfer a first frame of the video to be displayed to the display panel.

In 664, the host processor can receive a subsequent frame to be displayed. In one example, this can be a stored frame to be displayed. The subsequent frame can be divided into first region and second region as discussed above. The host processor refreshes first region of the display panel.

In 666, the host processor checks whether the second region needs to be refreshed. The second region, including slower-changing video content, can be refreshed at a lesser rate than the first region. It will be appreciated that the process can be extended to any number of regions, each region associated with its own refresh rate.

If no refresh of the second region is required, the process returns to 664 where the first region is refreshed with a subsequent frame. If a refresh is required, the process continues to 668.

In 668, host processor refreshes the second region of the subsequent frame. The process returns to 664 and continues until refreshing is no longer required, for example, the video content has completed playback.

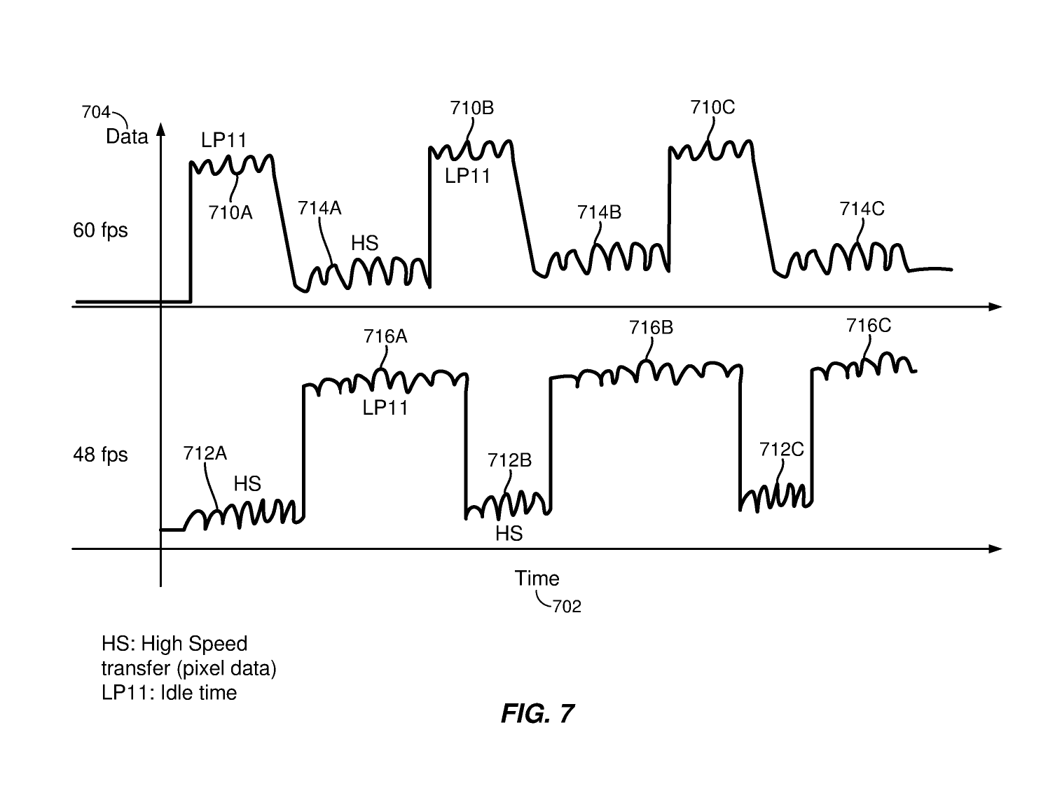

FIG. 7 illustrates an exemplary timing diagram enabling data transfer over two virtual channels at different refresh rates for different regions. It will be appreciated that as time passes on the horizontal axis 702, data is being transferred from the host processor to the display panel over a bus, as illustrated on the vertical axis 704.

As defined in the MIPI DSI specifications, the bus may have four data lanes and one clock lane. In one example, each virtual channel discussed above can be assigned to one data lane. If there are less than four virtual channels, one or more virtual channels can be assigned multiple data lanes for improved throughput. The host processor may ensure the total aggregated bandwidth required by the virtual channels does not exceed the available bandwidth or throughput of the bus. For example, the host processor may reduce the refresh rate in one or more regions where the displayed content is more static and less dynamic, and such a lower refresh rate does not impact user experience or create visual artifacts.

In one example, the MIPI DSI protocol and the associated hardware may be further extended to provide a faster clock in the clock lane. This will provide more granular refresh rates in the example process illustrated in FIG. 6A. For example, a clock rate of 100 MHz can support a frame rate of 100 frames per second. It can support a second region frame rates of 50 fps, 25 fps, or 12.5 fps, etc. This will provide better adaptability by the host processor to minimize refresh rates while preserving user experience.

Area 706 illustrates a data transfer over a bus for a first region at 60 fps. Area 708 illustrates a data transfer over the bus for a second region at 48 fps. It can be seen that the data transfer over the bus for the first region is idle in graph areas 710A, 710B, and 710C and in high speed transfer of pixel data in areas 714A, 714B, and 714C. Similarly, the data transfer over the bus for the second region is in high speed transfer of pixel data in areas 712A, 712B, and 712C, while idle in areas 716A, 716B, and 716C. As can be seen, the second region 708 has shorter data transfer periods and longer idle times compared to the data transfer for the first region 706 as it is transferring less pixel data required a lower frame rate of the second region.

Power savings from implementing the above processes can be computed. For example, almost 16 mA of SoC power savings can be expected based on simulation where a video-mode display panel is refreshed at 48 Hz as compared to 60 Hz. Additional power will be saved by the display panel as capacitors charging rate will be reduced. This power saving is subjective to panel fabrication.

TABLE 1
Example power savings from reducing refresh rate

| Content refresh | Panel refresh | SoC Power Consumption |
|---|---|---|
| rate | rate | (mA) |
| 48 fps | 48 Hz | 212.37 |
| 60 fps | 60 Hz | 196.74 |
| | | 15.63 savings |

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).
The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, a cache, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

1. A system for displaying image data, comprising:
a host processor configured to provide a frame of image data to a bus, the frame including a first frame region and a second frame region, wherein the first frame region is provided at a first refresh rate and the second frame region is provided at a second refresh rate, wherein the first refresh rate is faster than the second refresh rate; and
a video-mode display panel, the video-mode display panel including,
a bus interface coupled to the bus and configured to receive the frame, and
a display screen including a plurality of pixel elements for displaying the frame, wherein the first frame region is displayed at the first refresh rate and the second frame region is displayed at the second refresh rate.

2. The system of claim 1, wherein the first refresh rate is an integer multiple of the second refresh rate.

3. The system of claim 1, wherein
the second refresh rate exceeds a display screen minimum refresh rate, and
the second refresh rate exceeds a content refresh rate associated with the second frame region.

4. The system of claim 1, wherein the first frame region includes faster-changing image data displayed at the first refresh rate and the second frame region includes slower-changing image data displayed at the second refresh rate.

5. The system of claim 1, further comprising:
a timing controller, the timing controller configured to provide a first clock signal driving the first refresh rate and a second clock signal driving the second refresh rate, wherein the first refresh rate is independent of the second refresh rate. .

6. The system of claim 1, wherein the host processor is further configured to communicate a first offset associated with the first frame region and a second offset associated with the second frame region to the video-mode display panel before providing the stored frame to the bus.

7. The system of claim 6, wherein the first offset and the second offset are communicated via a DSI protocol extension command

8. The system of claim 6, wherein the video-mode display panel receives the frame, the first offset, and the second offset via the bus, wherein the bus is a DSI bus.

9. A method for displaying image data, comprising:
providing, by a host processor, a frame of image data to a bus, the frame including a first frame region and a second frame region, wherein the first frame region is provided at a first refresh rate and the second frame region is provided at a second refresh rate, wherein the first refresh rate is faster than the second refresh rate; and
receiving, by a bus interface coupled to the bus, the frame, and
displaying the frame, at a display screen including a plurality of pixel elements, wherein the first frame region is displayed at the first refresh rate and the second frame region is displayed at the second refresh rate, wherein the bus interface and the display screen are components in a video-mode display panel.

10. The method of claim 9, wherein the first refresh rate is an integer multiple of the second refresh rate.

11. The method of claim 9, wherein
the second refresh rate exceeds a display screen minimum refresh rate, and
the second refresh rate exceeds a content refresh rate associated with the second frame region.

12. The method of claim 9, wherein the first frame region includes faster-changing image data displayed at the first refresh rate and the second frame region includes slower-changing image data displayed at the second refresh rate.

13. The method of claim 9, further comprising:
providing, by a timing controller, a first clock signal driving the first refresh rate and a second clock signal driving the second refresh rate, wherein the first refresh rate is independent of the second refresh rate.

14. The method of claim 9, wherein the host processor is further configured to communicate a first offset associated with the first frame region and a second offset associated with the second frame region to the video-mode display panel before providing the stored frame to the bus.

15. The method of claim 14, wherein the first offset and the second offset are communicated via a DSI protocol extension command

16. The method of claim 14, wherein the video-mode display panel receives the frame, the first offset, and the second offset via the bus, wherein the bus is a DSI bus.

17. A system for displaying image data, comprising:
a host processing means to provide a frame of image data to a bus, the frame including a first frame region and a second frame region, wherein the first frame region is provided at a first refresh rate and the second frame region is provided at a second refresh rate, wherein the first refresh rate is faster than the second refresh rate; and
a video-mode display panel means, the video-mode display panel means including,
a bus interface means coupled to the bus and configured to receive the frame, and
a display screen means including a plurality of pixel elements for displaying the frame, wherein the first frame region is displayed at the first refresh rate and the second frame region is displayed at the second refresh rate.

18. The system of claim 17, wherein the first refresh rate is an integer multiple of the second refresh rate.

19. The system of claim 17, wherein
the second refresh rate exceeds a display screen minimum refresh rate, and
the second refresh rate exceeds a content refresh rate associated with the second frame region.

20. The system of claim 17, wherein the first frame region includes faster-changing image data displayed at the first refresh rate and the second frame region includes slower-changing image data displayed at the second refresh rate.

21. The system of claim 17, further comprising:
a timing controller means, the timing controller means configured to provide a first clock signal driving the first refresh rate and a second clock signal driving the second refresh rate, wherein the first refresh rate is independent of the second refresh rate.

22. The system of claim 17, wherein the host processor is further configured to communicate a first offset associated with the first frame region and a second offset associated with the second frame region to the video-mode display panel before providing the stored frame to the bus.

23. The system of claim 22, wherein the first offset and the second offset are communicated via a DSI protocol extension command

24. The system of claim 22, wherein the video-mode display panel receives the frame, the first offset, and the second offset via the bus, wherein the bus is a DSI bus.

25. A non-transient computer-readable storage medium containing program instructions for causing a computer to perform the method of:
providing, by a host processor, a frame of image data to a bus, the frame including a first frame region and a second frame region, wherein the first frame region is provided at a first refresh rate and the second frame region is provided at a second refresh rate, wherein the first refresh rate is faster than the second refresh rate; and
receiving, by a bus interface coupled to the bus, the frame, and
displaying the frame, at a display screen including a plurality of pixel elements, wherein the first frame region is displayed at the first refresh rate and the second frame region is displayed at the second refresh rate, wherein the bus interface and the display screen are components in a video-mode display panel.

26. The non-transient computer-readable storage medium of claim 25, wherein the first refresh rate is an integer multiple of the second refresh rate.

27. The non-transient computer-readable storage medium of claim 25, wherein
the second refresh rate exceeds a display screen minimum refresh rate, and
the second refresh rate exceeds a content refresh rate associated with the second frame region.

28. The non-transient computer-readable storage medium of claim 25, wherein the first frame region includes faster-changing image data displayed at the first refresh rate and the second frame region includes slower-changing image data displayed at the second refresh rate.

29. The non-transient computer-readable storage medium of claim 25, further comprising:
providing, by a timing controller, a first clock signal driving the first refresh rate and a second clock signal driving the second refresh rate, wherein the first refresh rate is independent of the second refresh rate.

30. The non-transient computer-readable storage medium of claim 25, wherein the host processor is further configured to communicate a first offset associated with the first frame region and a second offset associated with the second frame region to the video-mode display panel before providing the stored frame to the bus, wherein the first offset and the second offset are communicated via a DSI protocol extension command, wherein the video-mode display panel receives the frame, the first offset, and the second offset via the bus, wherein the bus is a DSI bus.
